(19) United States
(12) Patent Application Publication
(10) Pub. No.: US 2018/0202899 A1
(43) Pub. Date: Jul. 19, 2018

(54) System and method for measuring cleanliness of an engine cylinder block

(71) Applicant: Caterpillar Inc., Peoria, IL (US)

(72) Inventors: Stephen Johnson, Lafayette, IN (US); Kevin Paul Storms, Darlington, IN (US)

(21) Appl. No.: 15/407,631

(22) Filed: Jan. 17, 2017

(51) Int. Cl. G01M 15/02; F02B 77/08; F01M 11/10

(52) U.S. Cl. CPC G01M 15/02; F01M 11/10; F02B 77/083

(57) ABSTRACT

A cleanliness measuring system for an engine cylinder block includes a set of fittings configured for receipt at least partially within oil passage openings of a lubrication system of the engine cylinder block. Each of the fittings includes a fluid collection passage therethrough. The cleanliness measuring system also includes a set of fluid sampling bottles configured for attachment to the fittings. In an attached configuration of the cleanliness measuring system, each of the fluid sampling bottles is attached to one of the fittings and the fittings are secured within one of the oil passage openings, a fluid is introduced into the lubrication system, the fluid and any debris carried by the fluid from within oil passages of the engine cylinder block flow into the fluid sampling bottles, and debris collected in the fluid sampling bottles is measured to determine a cleanliness level of the engine cylinder block.

### TECHNICAL FIELD

The present disclosure relates generally to a system and method for measuring cleanliness of an engine cylinder block, and more particularly to collecting and measuring debris carried by a fluid that is captured within fluid sampling bottles positioned within oil passages of the engine cylinder block using fittings.

### BACKGROUND

Even if an engine cylinder block is newly manufactured and seemingly ready for use, it is important to ensure that the engine cylinder block, including the various passages therethrough, is clean. Any piece of debris, even of the smallest size, introduced to the engine cylinder block before use, such as during manufacturing or assembly, may scratch internal surfaces, such as, for example, cylinder and/or oil passage walls, and/or outer surfaces of reciprocating components. The debris, and the resulting wear, may ultimately lead to early engine failure.

Engine manufacturers may or may not have specialized equipment for cleaning engine blocks; however, smaller manufacturers and/or other groups offering the engine cylinder blocks to ends users, such as, for example, suppliers, or others that may sell or rebuild engine cylinder blocks, may not have access to the necessary cleaning equipment. As such, it is difficult to ensure cleanliness of the engine cylinder block, at least in certain scenarios.

U.S. Pat. No. 5,482,062 to Chen discloses an apparatus and method for flushing an automatic transmission system. In particular, a system or module for automatic transmission system fluid exchange and internal system flushing is provided. The system monitors normal operating conditions of the automatic transmission system with the engine turned on and the transmission gears shifted. The machine module measures the pressure and flow rate of the transmission fluid in transmission system conduits while at the same time allowing visual inspection of the condition of the transmission fluid and the amount of contaminants captured within a see-through filter.

As should be appreciated, there is a continuing need to ensure cleanliness of machine components, including the engine cylinder block, in a reliable and cost effective manner.

### SUMMARY OF THE INVENTION

In one aspect, a cleanliness measuring system for an engine cylinder block includes a set of fittings configured for receipt at least partially within oil passage openings of a lubrication system of the engine cylinder block. Each of the fittings includes a fluid collection passage therethrough. The cleanliness measuring system also includes a set of fluid sampling bottles configured for attachment to the fittings. In an attached configuration of the cleanliness measuring system, each of the fluid sampling bottles is attached to one of the fittings and the fittings are secured within one of the oil passage openings, a fluid is introduced into the lubrication system, the fluid and any debris carried by the fluid from within oil passages of the engine cylinder block flow into the fluid sampling bottles, and debris collected in the fluid sampling bottles is measured to determine a cleanliness level of the engine cylinder block.

In another aspect, a method of measuring cleanliness of an engine cylinder block using a cleanliness measuring system is provided. The method includes a step of positioning a set of fittings at least partially within oil passage openings of a lubrication system of the engine cylinder block. Each of the fittings includes a fluid collection passage therethrough. The method also includes steps of attaching a set of fluid sampling bottles to the fittings, introducing a fluid into the lubrication system, collecting the fluid and any debris carried by the fluid from within oil passages with the fluid sampling bottles, and measuring debris collected in the fluid sampling bottles to determine a cleanliness level of the engine cylinder block.

### BRIEF DESCRIPTION OF THE DRAWINGS

FIG. 1 is a semi-transparent perspective view of an exemplary engine cylinder block, according to the present disclosure;

FIG. 2 is a simplified block diagram of a lubrication system of the exemplary engine cylinder block of FIG. 1;

FIG. 3 is a partial perspective view of a bottom side of the exemplary engine cylinder block, illustrating openings of oil passages of the lubrication system;

FIG. 4 is a partial block diagram of the lubrication system corresponding to the partial view of FIG. 3;

FIG. 5 is a perspective view of exemplary cleanliness measuring system components for use with the exemplary engine cylinder block and lubrication system thereof;

FIG. 6 is a perspective view of an exemplary fluid sampling bottle and corresponding fitting from the exemplary cleanliness measuring system of FIG. 5;

FIG. 7 is a perspective view of the exemplary fluid sampling bottle and corresponding fitting of FIG. 6, shown in an attached configuration;

FIG. 8 is a cross-sectional view of the fitting of the previous FIGS.;

FIG. 9 is a partial perspective view of the bottom side of the exemplary engine cylinder block, shown with components of the exemplary cleanliness measuring system attached thereto;

FIG. 10 is a partial perspective view of a rear side of the exemplary engine cylinder block, illustrating an oil canister secured over an oil inlet at the rear side of the exemplary engine cylinder block; and

FIG. 11 is a partial perspective view of the rear side of the exemplary engine cylinder block, illustrating a cover plate secured over an opening to an oil galley at the rear side of the exemplary engine cylinder block.

### DETAILED DESCRIPTION

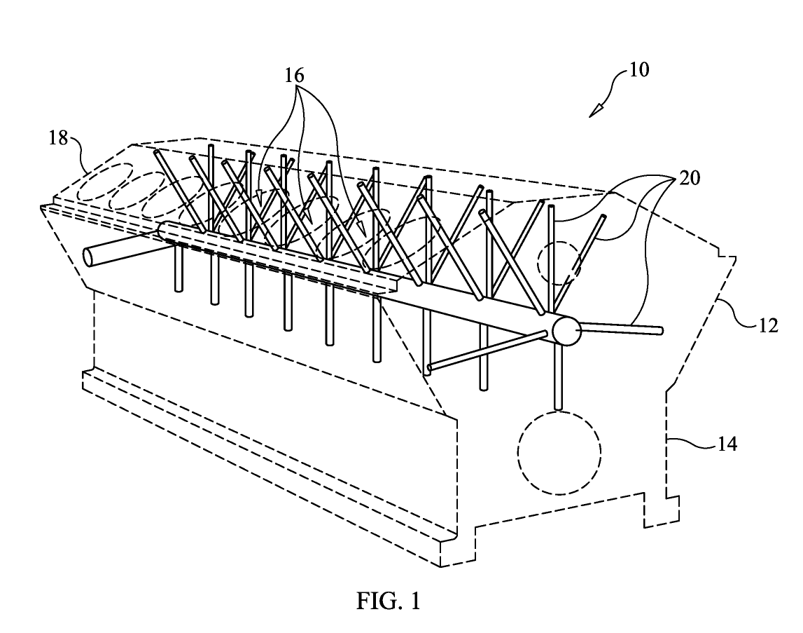

An exemplary embodiment of an engine cylinder block 10 is shown generally in FIG. 1. The engine cylinder block 10 may, for example, be constructed of cast iron or, alternatively, aluminum or magnesium, or any other desirable material, and may include one or more cylindrically bored holes for receiving pistons of an internal combustion engine, such as a compression ignition engine or a spark-ignited engine. It should be appreciated that such an internal combustion engine, which includes engine cylinder block 10, may be used to power an on-highway or off-highway machine, stationary equipment, or any other known machine or vehicle.

The engine cylinder block 10 may be a one-piece, or multiple piece, casting and may generally include an upper section 12 and a lower section 14. The upper section 12 may include a plurality of cylinder bores 16 formed within the engine cylinder block 10 and opening through a top deck 18 of the engine cylinder block 10. Although sixteen cylinder bores 16 are shown (eight on each side), it should be appreciated that the engine cylinder block 10 may include any number of cylinder bores 16, each of which may or may not include a cylinder liner.

As should be appreciated by those skilled in the art, a cylinder head (not shown) may be attached to the engine cylinder block 10, such as, for example, by using a plurality of attachment bolts that may be threadably received within a corresponding number of attachment bores. The cylinder head, as is known in the art, may seal each of the cylinder bores 16, thus creating combustion chambers therein, and may provide a structure for supporting intake and exhaust valves and/or ports, fuel injectors, necessary linkages, and/or other known devices or structures.

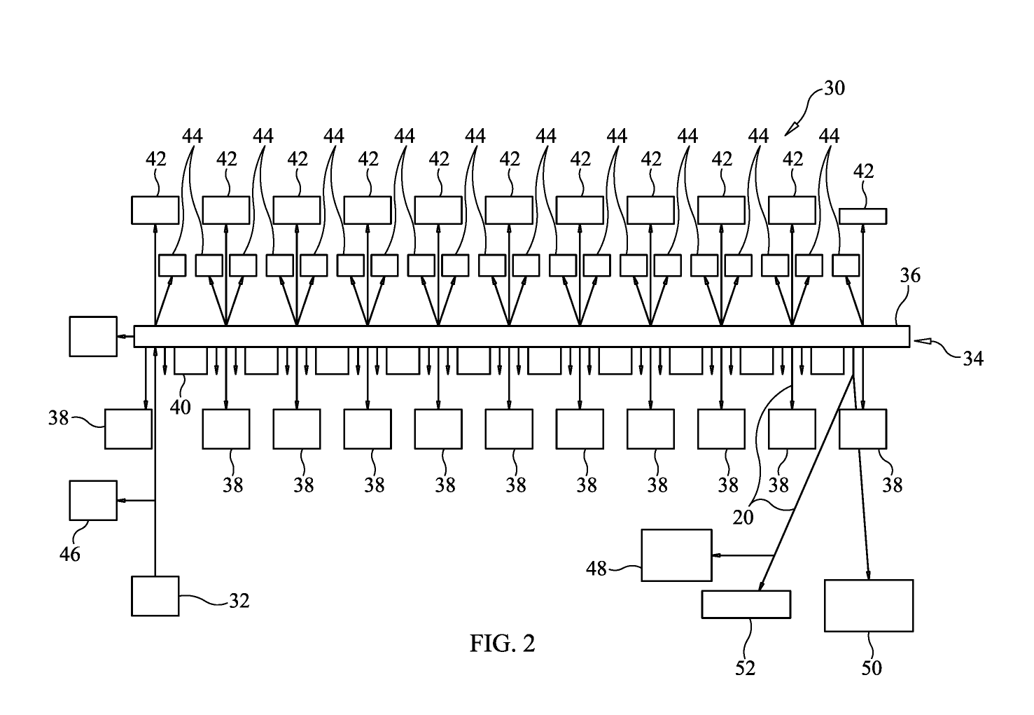

The engine cylinder block 10 may also include a plurality of fluid passages 20 formed therethrough (only a small portion of which are specifically called out), including those of a lubrication system 30, shown schematically in FIG. 2. The fluid passages 20 may be formed within the engine cylinder block 10 and may open through various surfaces of the engine cylinder block 10, including, as one example, the top deck 18. Lubrication systems for engines are known and provide multiple functions, including, for example, reducing friction and wear of moving parts, protecting parts from corrosion, and transferring heat to cool components of the engine cylinder block 10. Although specific embodiments are shown, it should be appreciated that a variety of different engine types and configurations and/or lubrication system types and configurations may benefit from the system and method disclosed herein.

Referring specifically to FIG. 2, the lubrication system 30 of the exemplary engine cylinder block 10 is shown using a simplified schematic diagram. That is, the passages 20 (only a portion of which are specifically called out) of the diagram of FIG. 2 correspond with the passages 20 shown in the engine cylinder block 10 of FIG. 1. Lubrication oil may be supplied to the engine cylinder block 10 from one or more inlets, such as, for example, a first inlet 32 and a second inlet 34. This lubrication oil is fed through the various passages 20 of the lubrication system 30 and is directed to various components, such as, for example, crank shaft bearings, cam shaft bearings, gears, piston rings and cylinder walls, and various other machine and/or engine components.

According to the exemplary embodiment, a main oil galley 36 may feed various oil passages 20, including those feeding a set of main bearings 38, those feeding a set of oil spray jets 40, those feeding a set of cam bearings 42, and those feeding a set of cylinder heads 44. As is shown in FIG. 1, oil passages 20 feeding the set of main bearings 38 and the set of oil spray jets 40 may be positioned at least partly within the lower section 14 of the engine cylinder block 10 and may be more vertically oriented than horizontally oriented. Additional passages 20 may feed various other components, including, for example, a stub shaft and power takeoff 46, front housing components such as a water pump drive and turbos 48, additional front housing components such as an air compressor drive and turbos 50, and an oil pressure regulator 52. Of course, various additional and/or alternative passages and openings may be provided, depending on the specific lubrication system or engine system. The embodiments depicted are shown for exemplary purposes only.

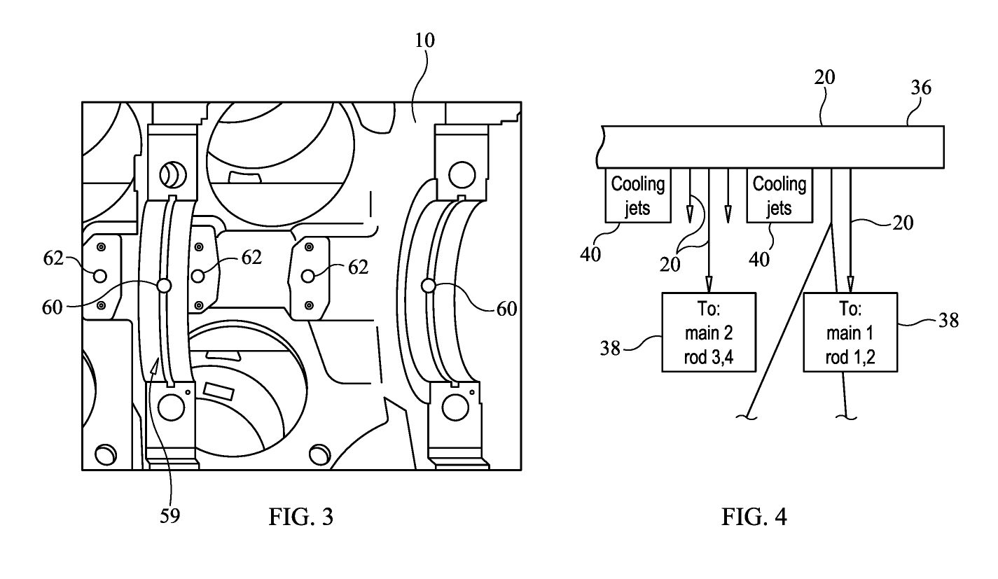

Turning now to FIG. 3, a portion of a bottom, or underneath, side 59 of the engine cylinder block 10 is shown. In particular, oil passage openings for some of the oil passages 20 described above are shown. That is, some of the main bearing feed openings 60 feeding the set of main bearings 38 are shown. Also depicted are some of the oil spray jet openings 62 that feed the set of oil spray jets 40. For ease of explanation, FIG. 4 depicts a portion of the schematic diagram of FIG. 2, corresponding to the view of FIG. 3.

FIG. 5 depicts at least a portion of a cleanliness measuring system, or cleanliness measuring kit, 70 for the engine cylinder block 10 described herein. Generally speaking, the cleanliness measuring system 70 may include a set of fittings 72, 74 configured for receipt at least partially within the oil passage openings 60, 62 of the lubrication system 30 of the engine cylinder block 10. In particular, main bearing oil supply fittings 72 may be sized, shaped, and configured to fit within the main bearing feed openings 60 in a manner described below, while the oil spray jet supply fittings 74 may be sized, shaped, and configured to fit within the oil spray jet openings 62.

Although only one of each of the fittings 72, 74 are shown, it should be appreciated that the cleanliness measuring system 70 may include a larger number of each of the fittings 72, 74, depending on the size of the engine cylinder block 10 and/or the configuration of the lubrication system 30. For example, a sixteen cylinder engine may have nine main bearing feed openings 60 and, therefore, may require nine main bearing oil supply fittings 72. The sixteen cylinder engine may also have sixteen oil spray jet openings 62 and, thus, may require sixteen oil spray jet supply fittings 74.

The cleanliness measuring system 70 may also include a set of fluid sampling bottles 76 configured for attachment to the fittings 72, 74, in a manner described below. The cleanliness measuring system 70 may include a number of the fluid sampling bottles 76 corresponding to the total number of fittings 72, 74 of the cleanliness measuring system 70. The fluid sampling bottles 76 may be scheduled oil sampling (SOS) bottles, which are known in the art. According to some embodiments, the cleanliness measuring system 70 may also include all SOS components required for performing an SOS analysis. Various additional or alternative components may also be provided, including, for example, a rear cover plate 78 for covering an end of the main oil galley 36 at a rear end of the engine cylinder block 10, and an oil canister 80 for positioning over an oil inlet, such as oil inlet 32 at a rear end of the engine cylinder block 10.

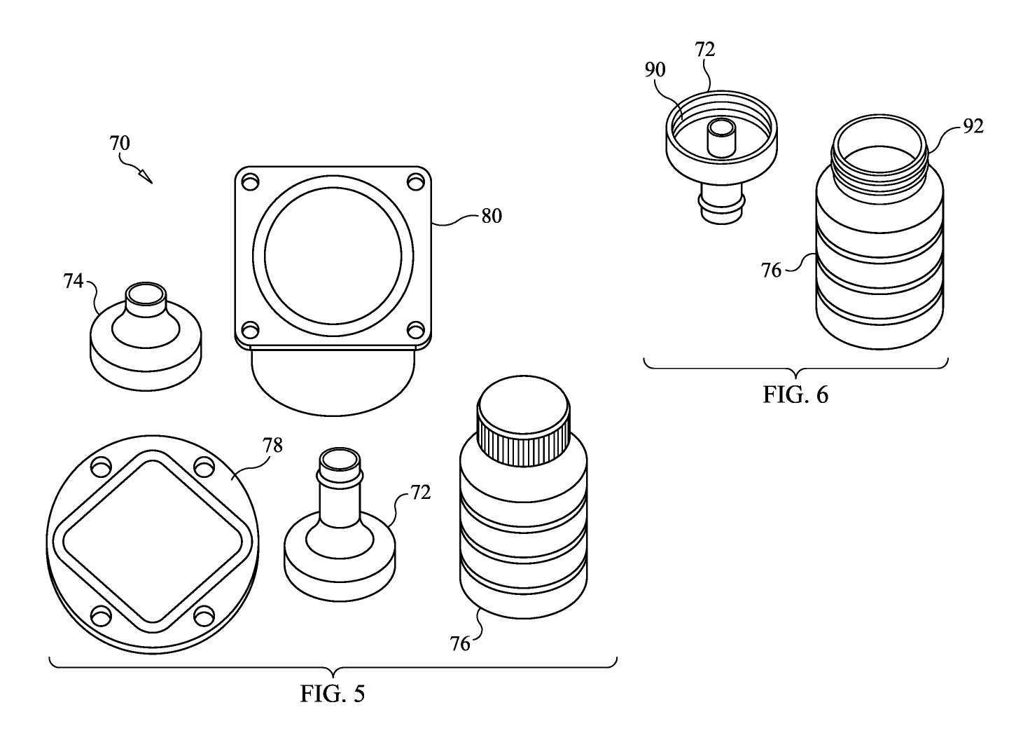

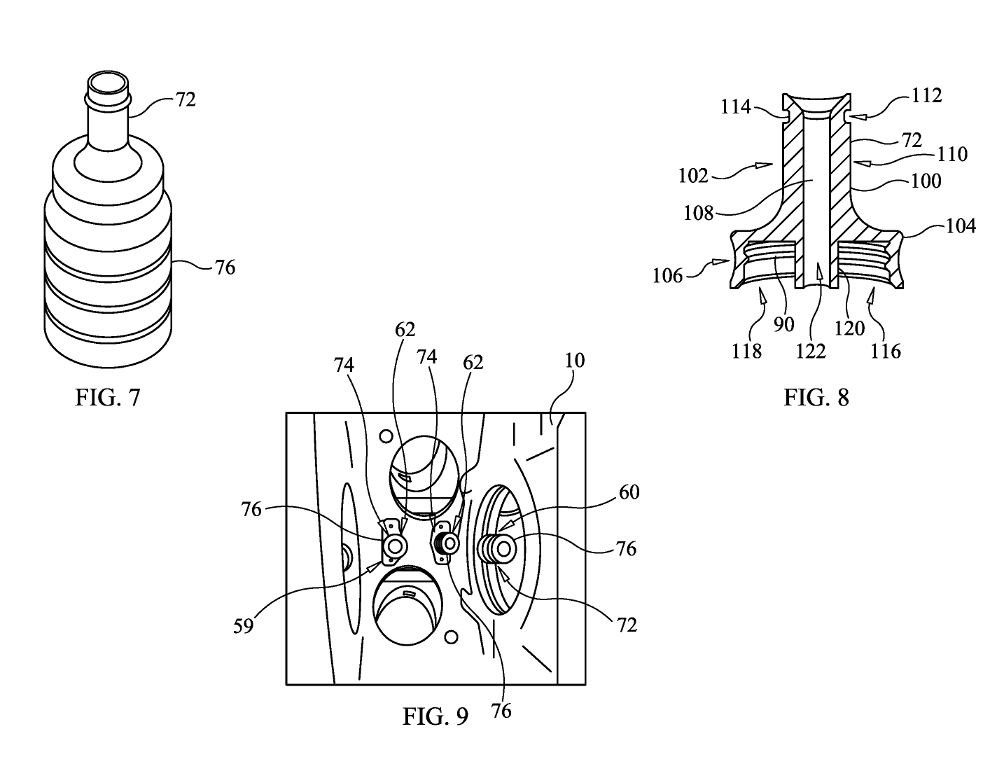

Turning now to FIGS. 6 and 7, one of the exemplary fittings 72 is shown in relation to one of the fluid sampling bottles 76. Each fitting 72, as well as each fitting 74, may include internal threads 90 for threadably engaging external threads 92 of one of the fluid sampling bottles 76. The illustrated fitting 72 and fluid sampling bottle 76 are shown in an attached configuration, in threaded engagement with one another, in FIG. 7. However, other attachment means may be used instead of the threaded engagement. The fittings 72, 74 and fluid sampling bottles 76 may be made from any suitable material(s), including plastics or metals, using any known process. According to some embodiments, the fittings 72, 74 may be manufactured using a 3D printing process.

FIG. 8 depicts a cross-sectional view of the exemplary fitting 72. As shown, the fitting 72 includes an elongate neck 100 at a top portion 102 of the fitting 72 and a widened base 104 at a bottom portion 106 of the fitting 72, with a fluid collection passage 108 defined therethrough. An outer surface 110 of the fitting 72 may include a circumferential groove 112 at the top portion 102 of the fitting 72, for at least partial receipt of an elastomeric seal 114. An interior surface 116 defined by the widened base 104 includes the internal threads 90. An internal space 118 defined by the widened base 104 may be circumferentially spaced from a wall or outer wall 120 of the fluid collection passage 108, such that the space 118 defined by the widened base 104 is separate from a space 122 defined by the fluid collection passage 108. That is, the wall 120, which at least partly defines the fluid collection passage 108 may fluidly separate the space 118 defined by the widened base 104 from the space 122 of the fluid collection passage 108.

FIG. 9 is a partial perspective view of the bottom side 59 of the exemplary engine cylinder block 10, shown with components of the exemplary cleanliness measuring system 70 in an attached configuration. According to the attached configuration, the fluid sampling bottles 76 are attached to the fittings 72, 74, as shown in FIG. 7, and the fittings 72, 74 are secured within one of the oil passage openings 60, 62. In particular, main bearing oil supply fittings 72 may be received within main bearing feed openings 60, and oil spray jet supply fittings 74 may be received within oil spray jet openings 62. The fittings 72, 74 may be frictionally engaged within the respective oil passage openings 60, 62, with the elastomeric seal 114 of each fitting 72, 74 fluidly sealing the engagement. However, other attachment means are also contemplated.

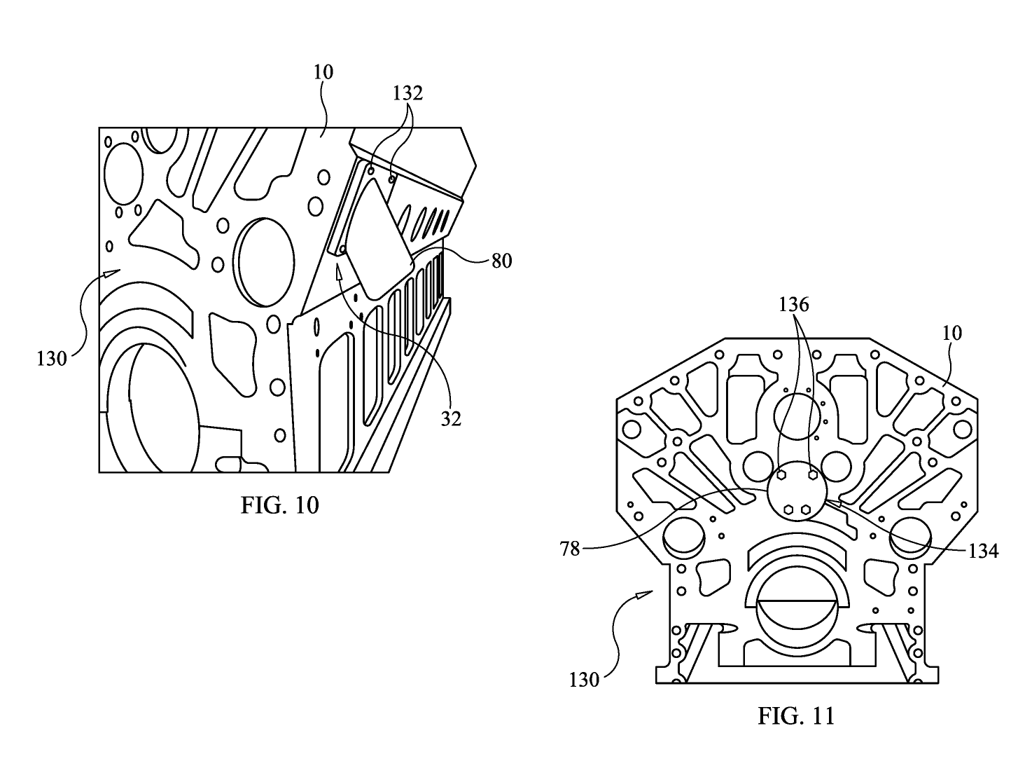

FIG. 10 is a partial perspective view of a rear side 130 of the exemplary engine cylinder block 10, illustrating the oil canister 80 secured over the oil inlet 32 at the rear side 130 of the exemplary engine cylinder block 10. For example, a set of bolts 132 may be used to attach the oil canister 80 to the exemplary engine cylinder block 10. FIG. 11 is a partial perspective view of the rear side 130 of the exemplary engine cylinder block 10, depicting the rear cover plate 78 positioned over an end 134 of the main oil galley 36 at the rear side 130 of the engine cylinder block 10. A set of bolts 136 may also be used to secure the rear cover plate 78 over the end 134 of the main oil galley 36. Although bolted connections are shown, either or both of the rear cover plate 78 and oil canister 80 may be attached to the engine cylinder block 10 using other known fastening means.

In the attached configuration of the cleanliness measuring system 70, as just described, the engine cylinder block 10 may be tested or evaluated for cleanliness. Typically, the engine cylinder block 10 should be cleaned using one or more conventional cleaning methods. In a first step, the engine cylinder block 10 may be slightly elevated at one end, such as, for example, at a front end 22 (FIG. 1) of the engine cylinder block 10. The engine cylinder block 10 may be oriented at an angle of less than approximately 45 degrees and may remain more horizontally oriented than vertically oriented. This orientation may permit gravity to assist in directing a fluid flow introduced into the engine cylinder block 10 downward and at least slightly toward the rear end, or side, 130 of the engine cylinder block 10.

A fluid, such as, for example, a liquid, which may or may not be pressurized and may or may not include chemicals therein, may be introduced into the passages 20 of the engine cylinder block 10. For example, the fluid may be introduced into the passages 20 of the lubrication system 30. According to an exemplary process, fluid may be introduced first at a top, or upper, portion 12 of the engine cylinder block 10 and, thereafter, at a bottom, or lower, portion 14 of the engine cylinder block 10. The fluid and any debris carried by the fluid from within oil passages 20 of the engine cylinder block 10 may flow into the fluid sampling bottles 76, and debris collected in the fluid sampling bottles 76 may be measured to determine a cleanliness level of the engine cylinder block 10. According to one exemplary embodiment, a known SOS analysis, which may include a filter or other device for capturing particles or debris, may be performed on the fluid and debris to arrive at a cleanliness level of the engine cylinder block 10.

### INDUSTRIAL APPLICABILITY

The present disclosure relates generally to a system and method for measuring cleanliness of an engine cylinder block and, more particularly, to collecting and measuring debris carried by a fluid that is captured within fluid sampling bottles positioned within oil passages of the engine cylinder block using fittings disclosed herein. The present disclosure is broadly applicable to cleaning, or measuring cleanliness, of a variety of different systems or components having fluid passages that should be relatively free of debris.

Referring generally to FIGS. 1-11, an exemplary embodiment of an engine cylinder block 10 is shown. The engine cylinder block 10 may be a one-piece, or multiple piece, casting and may generally include an upper section 12 and a lower section 14. The upper section 12 may include a plurality of cylinder bores 16 formed within the engine cylinder block 10 and opening through a top deck 18 of the engine cylinder block 10. The engine cylinder block 10 may also include a plurality of fluid passages 20, including those of a lubrication system 30, shown schematically in FIG. 2. The fluid passages 20 may be formed within the engine cylinder block 10 and may open through various surfaces of the engine cylinder block 10, including, for example, the top deck 18.

Even if the engine cylinder block 10 is newly manufactured or remanufactured and seemingly ready for use, it is important to ensure that the engine cylinder block 10, including the various passages 20 formed therethrough, is clean. Any piece of debris introduced to the engine cylinder block 10 before use, such as during manufacturing or assembly, may scratch internal surfaces, such as, for example, cylinder and/or oil passage walls, and/or outer surfaces of reciprocating components. The debris, and the resulting wear, may ultimately lead to early engine failure. To avoid this, and ensure a predetermined level of cleanliness, the system and method of the present disclosure may be used.

A cleanliness measuring system 70 of the present disclosure may include a set of fittings 72, 74 configured for receipt at least partially within the oil passage openings 60, 62 of the lubrication system 30 of the engine cylinder block 10. In particular, main bearing oil supply fittings 72 may be sized, shaped, and configured to fit within the main bearing feed openings 60, while the oil spray jet supply fittings 74 may be sized, shaped, and configured to fit within the oil spray jet openings 62. That is, the top portion 102 of each fitting 72, 74 may be secured within the oil passages 60, 62 using an interference fit. The elastomeric seal 114 may assist in the frictional engagement and may seal the connection.

The cleanliness measuring system 70 may also include a set of fluid sampling bottles 76 configured for attachment to the fittings 72, 74. The cleanliness measuring system 70 may include a number of the fluid sampling bottles 76 corresponding to the total number of fittings 72, 74 of the cleanliness measuring system 70. Each fitting 72, 74 may include a fluid collection passage 108, defined at least partly by wall 120, extending therethrough that will assist in directing fluid into the fluid sampling bottle 76 that might otherwise escape from the fluid sampling bottle 76 at the respective threads 90, 92.

Various additional or alternative components may also be provided, including, for example, a rear cover plate 78 for covering an end of the main oil galley 36 at a rear side or end 130 of the engine cylinder block 10, and an oil canister 80 for positioning over an oil inlet, such as oil inlet 32 at the rear side or end 130 of the engine cylinder block 10. These components 78, 80 may block fluid from passing through the respective openings and exiting the engine cylinder block 10.

After the fluid sampling bottles 76 are attached to the fittings 72, 74 and the fittings 72, 74 are received within the main bearing feed openings 60 and the oil spray jet openings 62, fluid may be introduced into the lubrication system 30. According to one example, this “flushing” process may start from the top, or upper section 12, of the engine cylinder block 10, such as, for example, through camshaft holes, or other openings at a top portion of the engine cylinder block 10, and progress downward. Side oil passages 20 may be flushed next, by passing the fluid therethrough. After that, passages 20 from the bottom of the cam galley to the main oil galley may be flushed. Finally, each cylinder head oil supply hole extending from the top of the engine cylinder block 10 to the main oil galley may be flushed. It should be appreciated that gaining access to the desired openings and passages may require the use of additional instruments, such as, for example, a spray gun, extension tube and angled fitting. Regardless of the sequence, all desired passages 20, such as those of the lubrication system 30, may be flushed such that gravity leads the fluid and any debris carried therewith downward and into the fluid sampling bottles 76.

The fluid and any debris carried by the fluid from within oil passages 20 of the engine cylinder block 10 may be collected within the fluid sampling bottles 76. The fluid and debris may then be analyzed to determine a cleanliness level of the engine cylinder block 10. That is, the fluid may be passed through a filter or device that collects the debris therein for analysis. Various criteria may be used to analyze the fluid and arrive a cleanliness level for the engine cylinder block 10. For example, particles to be measured for size may include metallic, rust, sand, and other abrasives. Largest particle allowed, maximum number of particles allowed per given particle length, max mass allowed and/or abrasives or oxides greater than a certain size may also be considerations. Ultimately, if any value exceeds any predetermined limit or threshold, the engine cylinder block 10 should be rewashed and the inspection performed again until the desired level of cleanliness is achieved.

The present disclosure provides a means for measuring the cleanliness of an engine cylinder block in a reliable and cost effective manner. It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A cleanliness measuring system for an engine cylinder block, including:
a set of fittings configured for receipt at least partially within oil passage openings of a lubrication system of the engine cylinder block, wherein each of the fittings includes a fluid collection passage therethrough; and
a set of fluid sampling bottles configured for attachment to the fittings;
wherein, in an attached configuration of the cleanliness measuring system, each of the fluid sampling bottles is attached to one of the fittings and the fittings are secured within one of the oil passage openings, a fluid is introduced into the lubrication system, the fluid and any debris carried by the fluid from within oil passages of the engine cylinder block flow into the fluid sampling bottles, and debris collected in the fluid sampling bottles is measured to determine a cleanliness level of the engine cylinder block.

2. The cleanliness measuring system of claim 1, wherein an outer surface of each fitting includes a circumferential groove at a top portion of the fitting.

3. The cleanliness measuring system of claim 2, further including an elastomeric seal positioned at least partially within the circumferential groove.

4. The cleanliness measuring system of claim 1, wherein the fitting includes an elongate neck at a top portion of the fitting and a widened base at a bottom portion of the fitting, wherein an interior surface defined by the widened base includes a plurality of threads.

5. The cleanliness measuring system of claim 4, wherein the interior surface defined by the widened base is circumferentially spaced from an outer wall of the fluid collection passage.

6. The cleanliness measuring system of claim 5, wherein a first space defined by the fluid collection passage is separate from a second space defined by the widened base.

7. The cleanliness measuring system of claim 4, wherein a first internal space defined by an interior surface of the widened base is separated from the fluid collection passage by a wall defining the fluid connection passage.

8. The cleanliness measuring system of claim 1, wherein, in the attached configuration of the cleanliness measuring system, the fittings are frictionally engaged within the oil passage openings.

9. The cleanliness measuring system of claim 1, wherein, in the attached configuration of the cleanliness measuring system, the fluid sampling bottles are in threaded engagement with the fittings.

10. The cleanliness measuring system of claim 1, wherein the oil passages are more vertically oriented than horizontally oriented.

11. The cleanliness measuring system of claim 1, wherein the engine cylinder block is more horizontally oriented than vertically oriented.

12. A method of measuring cleanliness of an engine cylinder block using a cleanliness measuring system, including steps of:
positioning a set of fittings at least partially within oil passage openings of a lubrication system of the engine cylinder block, wherein each of the fittings includes a fluid collection passage therethrough;
attaching a set of fluid sampling bottles to the fittings;
introducing a fluid into the lubrication system;
collecting the fluid and any debris carried by the fluid from within oil passages with the fluid sampling bottles; and
measuring debris collected in the fluid sampling bottles to determine a cleanliness level of the engine cylinder block.

13. The method of claim 12, further including positioning an elastomeric seal at least partially within a circumferential groove of an outer surface of a top portion of each fitting.

14. The method of claim 12, wherein the fitting includes an elongate neck at a top portion of the fitting and a widened base at a bottom portion of the fitting; wherein an interior surface defined by the widened base is circumferentially spaced from an outer wall of the fluid collection passage; and wherein a first space defined by the fluid collection passage is separate from a second space defined by the widened base.

15. The method of claim 12, further including frictionally engaging the fittings within the oil passage openings.

16. The method of claim 15, further including threading the fluid sampling bottles into engagement with the fittings.

17. The method of claim 12, wherein the oil passages are more vertically oriented than horizontally oriented.

18. The method of claim 12, further including orienting the engine cylinder block more horizontally than vertically.

19. The method of claim 12, further including introducing the fluid into the engine cylinder block first at a top portion of the engine cylinder block and thereafter at a bottom portion of the engine cylinder block.

20. The method of claim 12, further including securing a plate over a cylinder block opening at an end of a main oil galley at a rear of the engine cylinder block.
